(19) United States
(12) Patent Application Publication
(10) Pub. No.: US 2004/0148203 A1
(43) Pub. Date: Jul. 29, 2004

(54) Systems and methods for verifying medical insurance coverage

(75) Inventors: Charles Whitaker, Omaha, NE (US); Bradley Winking, Omaha, NE (US); Scott Dunn, Omaha, NE (US); Jim Jackson, Tamarac, FL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First Data Corporation, Englewood, CO (US)

(21) Appl. No.: 10/675,929

(22) Filed: Sep. 29, 2003

Related U.S. Application Data
(60) Provisional application No. 60/417,205, filed on Oct. 8, 2002.

(51) Int. Cl. G06F 17/60

(52) U.S. Cl. 705/4; 705/35

(57) ABSTRACT

A method of verifying insurance coverage relating to a member includes receiving at a financial transaction processing computer system a member identifier relating to the member and searching a database to determine if the member identifier is valid. The method also includes transmitting from the financial transaction processing computer system authorization information.

### CROSS-REFERENCES TO RELATED APPLICATIONS

The application is a non-provisional of and claims the benefit of U.S. Provisional Patent Application No. 60/417,205, entitled “SYSTEMS AND METHODS FOR VERIFYING MEDICAL INSURANCE COVERAGE,” filed on Oct. 8, 2002, the entire disclosure of which is incorporated herein by reference for all purposes.

### BACKGROUND OF THE INVENTION

The present invention relates to verifying insurance coverage. More particularly, the present invention relates to systems and methods for using financial transaction processing networks to verify and/or process insurance-related information.

It has been reported that a large percentage of medical claims are initially denied. Reasons include lack of coverage, changed coverage, failure to obtain pre-authorization or a referral, incorrect co-payment, and the like. In a number of cases, denied claims are eventually paid. These claims could have been paid initially, however, had certain information been available at the time service was rendered. Thus, systems and methods are needed for verifying medical insurance coverage more efficiently.

### BRIEF SUMMARY OF THE INVENTION

Embodiments of the invention thus provide a method of verifying insurance coverage relating to a member. The method includes receiving at a financial transaction processing computer system a member identifier relating to the member and searching a database to determine if the member identifier is valid. The method also includes transmitting from the financial transaction processing computer system authorization information. In some embodiments, the financial transaction processing computer system comprises a credit card processing system. The member identifier may be received in credit card number format. The method may include receiving an individual code at the financial transaction processing computer system. The individual code may be received in a format relating to currency. The insurance coverage may relate to medical insurance. The method may include receiving at the financial transaction processing computer system an identifier relating to a provider. The method may include determining whether the provider is a network provider. The authorization information may indicate a denial of coverage. The authorization information may include a co-payment.

In other embodiments, a method of verifying insurance coverage relating to a member includes entering member identifier information into a credit card processing device, transmitting the information to a host computer system, and receiving authorization information at the processing device indicating whether the member has insurance coverage. The identifier information may include an individual code in a currency field. The authorization information may include a co-payment. The authorization information may indicate a denial of coverage. Entering member identifier information may include swiping an insurance card. The insurance card include credit card stock.

In other embodiments, an insurance card includes an account number in credit card number format, a machine-readable storage medium, and a list of covered members. The insurance card may include credit card stock. The insurance card may relate to medical insurance.

IN still other embodiments, a method of enrolling a member into medical coverage includes receiving enrollment information from the member and assigning an account to the member. The account may be in credit card format. The method also includes ssigning a code to each covered dependent of the member. Each dependent's code may be in currency format. The method also includes producing a card for the member. The card may include credit card stock. In some embodiments, the method includes producing dependent codes on the card. The method may include entering pre-tax spending account information relating to the member.

In yet other embodiments, a system for processing insurance information includes a credit card processing network and a host computer system. The host computer system is programmed to receive insurance information from a point-of-sale device via the credit card processing network and verify coverage. The host computer system may be programmed to determine a dependent's coverage. The host computer system may be programmed to determine if a provider is a network provider. The host computer system may be programmed to transmit an approval code. The approval code may include a co-payment. The approval code may include a denial of coverage.

### BRIEF DESCRIPTION OF THE DRAWINGS

A further understanding of the nature and advantages of the present invention may be realized by reference to the remaining portions of the specification and the drawings wherein like reference numerals are used throughout the several drawings to refer to similar components.

FIG. 1 illustrates a system for verifying insurance coverage using a credit card network according to the present invention.

FIG. 2 illustrates an insurance card according to embodiments of the present invention.

FIG. 3 illustrates a method of verifying insurance information according to embodiments of the present invention.

FIG. 4 illustrates a method of enrolling a member for insurance coverage according to the present invention.

FIG. 5 illustrates a method of paying funds from a Medical Savings Account/Flexible Spending Account (MSA/FSA).

### DETAILED DESCRIPTION OF THE INVENTION

The present invention provides systems and methods for verifying insurance coverage and/or processing certain insurance-related information. According to the present invention, a financial transaction processing network, such as a credit card processing network, is used in a novel way to provide insurance verification. This is advantageous because credit card processing devices may be used without modification to enter insurance information and receive an approval code that may include information such as a co-payment. Thus, the present invention provides enhanced insurance processing to service providers without the need for costly modification or replacement of hardware.

Point-of-sale (POS) devices are widely used by merchants and service providers to pre-authorize credit card payments. Upon being presented with a credit card for payment, a service provider, such as a doctor, enters information from the credit card into a POS. In one well-known example of a credit card pre-authorization process, the service provider also 5 enters the amount of the bill into the POS device. Information is then transmitted from the POS, through a credit card processing network, to a credit card processing host computer system. The host computer system uses the information to validate the credit card account number, verify that the amount does not exceed the cardholder's spending limit, confirm that the card has not been reported stolen, and the like. In response, the host computer system transmits to the POS an approval code that appears on a display screen of the POS. The approval code provides the service provider further confidence that the service provider will receive payment for the services. Many merchants, including medical professionals, have acquired such POS devices and subscribe to services that provide pre-authorization of credit card transactions because of this increased level of confidence.

The present invention uses the same POS device to access an insurance verification system. According to the present invention, a covered member (i.e., someone having insurance coverage) receives an insurance card that resembles a credit card. For example, the card may be a health insurance card that represents the covered member's health care coverage. The card is encoded with an account number that may have the same format as a credit card, but includes numbers that identify it as a health insurance card. When the member or someone in his family visits a doctor's office for medical care, a clerk at the doctor's office may request the card to verify the member's coverage. Information from the card may be entered into a POS. Additionally, the clerk enters an “amount,” just as the clerk would for a credit card pre-authorization. In this case, however, the amount serves to identify the family member that is the patient being treated on this visit—information that is typically required for health insurance processing. The information is then transmitted to the insurance verification computer system.

Upon receiving the information, the insurance verification computer system may verify the patient's eligibility for insurance coverage, determine the status of the doctor vis-à-vis the patient's insurance coverage, determine the patient's co-payment, and the like. The insurance verification computer system then returns an “approval code,” just as would be the case for a credit card pre-authorization. In this case, however, the approval code includes information relating to the member's health insurance. The information may include, for example, an indication of whether the coverage is in force, the member's co-payment, and the like. Thus, without the need for additional hardware or hardware modifications at service provider locations, the present invention enables real-time verification of insurance coverage.

Although in some embodiments the invention may be described in the context of a POS device that is used without modification, in other embodiments the POS device could be configured to receive inputs in forms that resemble traditional insurance information. Then mention how the back end processing could be modified as well to recognize that insurance verification information is being transmitted.

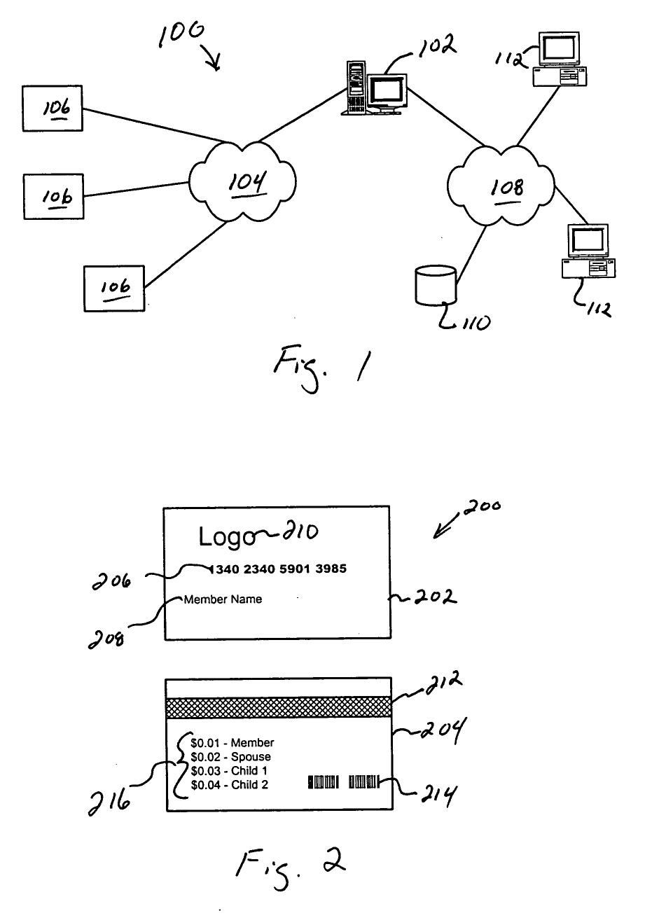

Having described the present invention generally, attention is directed to FIG. 1, which illustrates a system 100 according to the present invention. As will be explained in more detail hereinafter, the system 100 may be used to verify insurance coverage, process insurance claims, pay claims, and/or the like. It should be understood that the examples used herein relate to medical insurance. However, this is not a requirement. Other types of insurance and prepaid services may benefit from the teachings herein, as is apparent to those skilled in the art in light of this disclosure.

The system 100 includes a host computer system 102. The host computer system 102 may include, for example, a server computer, a personal computer, a workstation, or other suitable computing device. The host computer system 102 includes application software that programs the host computer system 102 to perform one or more functions according to the present invention. For example, application software resident on the host computer system 102 may program the host computer system 102 to receive and process credit card transaction information. The host computer system 102 may include one or more of the aforementioned computing devices, as well as storage devices such as databases, disk drives, optical drives, and the like. The host computer system 102 may be fully located within a single facility or distributed geographically, in which case a network may be used to integrate the host computer system 102. Many other examples are possible and apparent to those skilled in the art in light of this disclosure. Thus, this example of a system 100 according to the present invention is not to be considered limiting.

The system 100 also includes a first communication network 104. The network 104 may be the Internet, an intranet, a wide area network (WAN), a local area network (LAN), a virtual private network, and combination of the foregoing, or the like. The network 104 may include both wired and wireless connections, including optical links. In some embodiments, the network 104 is a credit card transaction processing network. Through the network 104, point-of-sale devices 106 communicate with the host computer system 102.

The point-of-sale (POS) devices 106 may be any device capable of receiving credit card transaction information and transmitting the information through a communication link, such as the network 104, to a processing system, such as the host computer system 102. Such devices are typically located in places of business that accept credit cards as payment for services. For example, most doctor's offices have POS devices to process credit cards.

Credit card transaction processing devices, such as the POS devices 106, are well know. For example, such devices are described fully in co-pending, commonly assigned U.S. Pat. App. No. 10/116,689, entitled “SYSTEMS AND METHODS FOR PERFORMING TRANSACTIONS AT A POINT-OF-SALE,” filed Apr. 3, 2002, by Earney Stoutenburg, et al., which is a continuation-in-part of U.S. Pat. App. No. 09/634,901, entitled “POINT OF SALE PAYMENT SYSTEM,” filed Aug. 9, 2000, by Randy J. Templeton et al., which is a non-provisional of U.S. Prov. App. No. 60/147,899, entitled “INTEGRATED POINT OF SALE DEVICE,” filed Aug. 9, 1999 by Randy Templeton et al., the entire disclosures of which are herein incorporated by reference for all purposes.

The system 100 also includes a second network 108, which may be any of the aforementioned networks. The network 108 and the network 104 may be the same network, different networks, or portions of a larger network. The network 108 provides a connection between the host computer system 102 and a medical information database 110, among other things.

The medical information database 110 may be any storage arrangement that provides access to data. It may include a computing device that supports such access. The storage device may include solid state memory, such as RAM, ROM, PROM, and the like, magnetic memory, such as disc drives, tape storage, and the like, and/or optical memory, such as DVD. The database 110 may be co-located with the host computer system 102, it may be integral with the host computer system 102, or it may be located apart from the host computer system 102. The system 102 also may include one or more user terminals 112 for entering information, accessing information, transferring information, and the like. For example, a user may enter enrollment information relating to covered members into the medical information database 110 via a user terminal 112. The user terminals 112 may be any of the aforementioned computing devices.

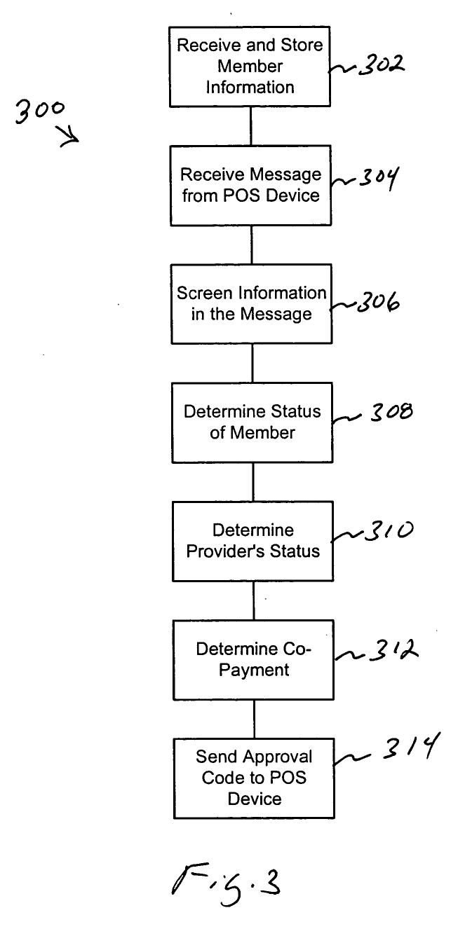

In some embodiments of the present invention, a user, such as a medical insurance provider, enters information relating to members into the medical information database 110. The information for each member may include the member's name, identification number, such as a social security number, the names of the member's dependents, the type of coverage the member has, the member's address, phone number, date of birth, and the amount of money, if any, the member has elected to contribute to a pre-tax savings account, such as a Medical Savings Account/Flexible Spending Account (MSA/FSA). The member receives an insurance card, which includes many features common with standard credit cards, as will be discussed below with respect to FIG. 2.

When a patient requests medical services at a patient care or health care facility such as a doctor's office, the patient presents the insurance card to the health care services provider. The services provider “swipes” the card through a reader associated with a POS device, such as one of the devices 106, or otherwise enters the information into the POS device 106. In a manner similar to the process for obtaining an approval code when a credit card holder presents a credit card for payment for goods or services, the service provider enters an “amount” upon receiving a prompt from the POS device to do so. However, instead of entering information that represents a fee for services, the service provider enters an “amount” that is a code identifying the member or one of the member's dependents as the patient. The codes may be listed, for example, on the insurance card, as will be described.

Once the amount is entered, electronic information is transmitted from the POS device 106, through the network 104, to the host computer system 102. The electronic information may include the member's insurance account number, the provider's identification number, the patient, and/or the like. In short, the transaction appears to be a typical credit card transaction. However, the member's account number or other data field identifies the transaction to be a request for medical insurance coverage verification, and the host computer system recognizes it as such.

In response, the host computer system 102 initiates a process to verify coverage and return to the POS 106 an “approval code” that may represent the patient's co-payment, for example. The “approval code” is not necessarily an “approval” for the services requested. The terminology “approval code” is used because of the analogous information in a credit card pre-authorization process. However, because the present invention may only provide an exchange of information between a POS and a host computer system, the term “approval code” should not be taken literally to mean that the services are being approved. The approval code is then displayed on the POS device. The verification process will be discussed in more detail hereinafter with respect to FIG. 3. However, the process may include searching in the medical information database 110 for the provider and the member.

Upon receipt of the approval code, the service provider will know whether the patient is covered and, if so, the required co-payment. For example, the approval code may include six digits, the first three of which represent coverage information, while the remaining three represent the patient's co-payment. Other such examples are possible. If the patient is not covered, the service provider may require payment at the time services are rendered, deny service, or provide service with the knowledge that the patient may not have medical insurance. In either case, the present invention provides the advantage of instant access to medical information without the need for a provider to invest in new technology.

According to some embodiments of the present invention, the member may elect to place money into a MSA/FSA and have co-payments and non-covered fees paid directly from this account. For example, the member may make such an election at the time of enrollment. When the member's presents his card for services, the verification process may include checking for such an election. If the member has so elected, the approval code may include an indication that the member has elected to have his co-payment deducted automatically from his MSA/FSA. This process, which will be explained more fully hereinafter with respect to FIG. 5, provides an additional enhancement to the processing and payment of medical insurance claims.

Having described the present invention generally, attention is directed to FIG. 2, which illustrates an insurance card 200 according to embodiments of the present invention. The insurance card 200, in this example, shares many similarities with a typical credit card. Both the front 202 and back 204 of the card 200 are pictured in FIG. 2. The front 202 includes an account number 206 and the member's name 208. The front 202 of the card 200 also may include a logo 210 indicating the insurance provider.

The back 204 of the card 200 may include a magnetic strip 212 and/or a bar code 214 such as a UPC (Universal Product Code). Either or both of the magnetic stripe 212 and the bar code 214 may be used to transmit information from the card 200 to a POS. Also on the back 204 is a list of dependent codes 216. These codes 216, which appear in currency format, are used to identify a member or dependent as a patient for a particular verification process. For example, as mentioned previously, when the health services provider enters an “amount” into the POS, the amount may correspond to the dependent listed on the card.

Attention is now directed to FIG. 3, which illustrates a method 300 of verifying medical coverage according to embodiments the present invention. At operation 302, member information is received and stored at a database, such as the medical information database 110 of FIG. 1. The information may include a member's name, address, account number, covered dependents, dates of birth for each covered member of the member's family, and the like. The information also may include an indication of whether the member contributes money to a MSA/FSA, how much, and whether the member wishes co-payments and non-covered expenses to be deducted automatically from the account. In some embodiments, data in the medical information database is sent periodically to the host computer system.

At operation 304, the host computer system receives a message from a POS that requests verification of medical insurance coverage. The message may include the member's account number, the provider's identification number, the patient, and other useful and/or necessary information. Because the message includes information particular to an insurance verification request, rather than a credit card approval request, the host computer system knows to treat the message differently. For example, the account number may be within a number series that the host computer system recognizes as an insurance number, rather than a credit card number. The “amount” may be a code for the patient, such as $0.03 for child 1 from the back of the insurance card discussed with respect to FIG. 2. Other examples of how the host computer system recognizes the message to be an insurance verification request are possible.

At operation 306, the host computer system may perform an initial screening based on information in the message from the POS. For example, while the host computer system may recognize that the member's account number is in the format of a medical account, as opposed to a credit card account, the account may nevertheless not be a valid account. Further, the “amount” field may include a number that is out of range of what is allowable for patient codes. Further still, the provider may not be an authorized provider, or the POS device may not be at a location approved for processing medical insurance information. Other screening examples are possible. If any screening test indicates that the information may not be valid, the host computer system may return a “decline” message to the POS that transmitted the message.

At operation 308, the host computer system searches the medical information database to determine the status of the member identified by the account number. If the member is not a current member, then the host computer system may return a decline message to the POS. If the member is covered, information relating to the member's coverage may be identified for future reference. In some embodiments, the host computer system searches a database, or other storage device, associated with the host computer system, instead of the medical information database. According to these embodiments, the data from the medical information database is sent periodically to the host computer system. In other embodiments, the host computer system may search its own data storage device first, then search the medical information database if the needed information is not found within the host computer system. Many other examples are possible. The same processes may apply to operation 310, described immediately hereinafter.

At operation 310, the host computer system may search the medical information database for information relating to the provider. For example, the provider may not be a participating provider, the provider may not be within the insurance provider's network, the provider may not be authorized to process medical information according to the present invention, or the like. In any of these cases, the host computer system may return a decline message to the POS. However, of the provider is approved, the host computer system may identify information for future reference.

At operation 312, the host computer system determines the member's co-payment, based on, for example, information relating to the member's coverage and the provider. The host computer system also may determine other necessary information for providing an approval code. For example, it may be relevant to the processing of the member's coverage whether the provider is a “network” provider. Network providers may subject the patient to a co-payment, while non-network providers may subject the patient to a charge equal to, foe instance, 20% of the total fee for services. Many other example are possible.

At operation 314, the foregoing information is compiled into a message that may be either an approval code, that may include a co-payment field, or a decline message. The message is then transmitted to the POS that requested verification of coverage. In some embodiments the approval code has the same number of digits as an approval code for a credit card pre-authorization request. Thus, the POS routinely used by the health services provider needs no modification to properly display the approval code for insurance verification. The approval code for insurance verification, however, transmits different information, as previously mentioned.

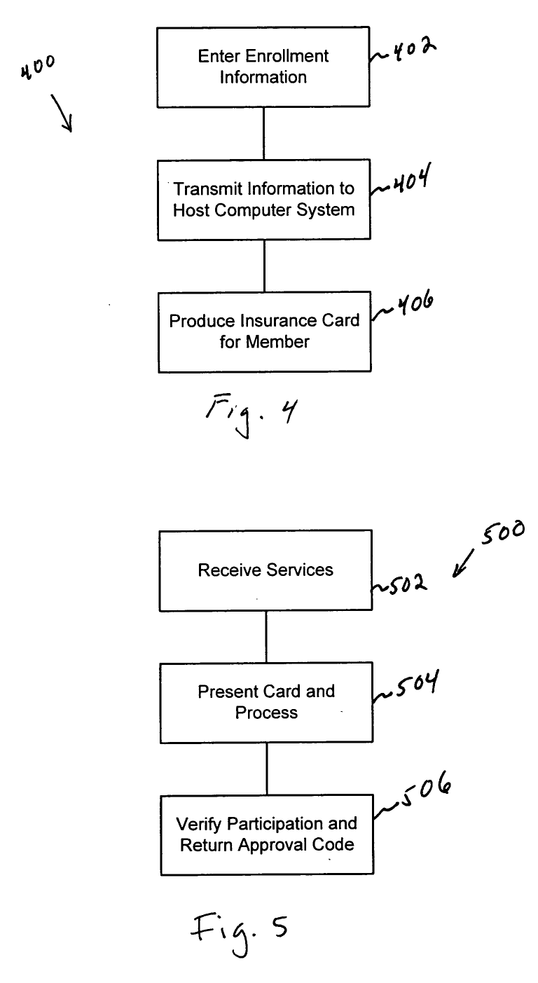

Attention is now directed to FIG. 4, which illustrates a method 400 of enrolling a member for medical coverage according to the present invention. At operation 402, enrollment information is entered into a database, such as the medical information database. The information may include the member's name and address, date of birth, social security number, dependents' names, social security numbers, and dates of birth, and the like. The enrollment information also may include an amount of money the member elects to contribute to a MSA/FSA, and whether the member pre-authorizes payment, from the MSA/FSA, co-payments and non-covered fees.

At operation 404, at least a porion of the content of the medical information database is transmitted to the host computer system. The information may be used to compile a cross reference table to facilitate future searches. The information may be “refreshed,” according to operation 404, periodically. For example, the medical information may be programmed to periodically transmit new, modified, and/or deleted information to the host computer system. In this way, the host computer maintains current information relating to covered members.

At operation 406, a medical insurance card may be created and presented to the member. In some embodiments, each covered member of the member's family receive a card. The card includes, in credit card format, an account number that relates the member to information stored in the database about the member's coverage. If the member's coverage changes, it may not be necessary for the member to receive a new medical card.

Attention is directed to FIG. 5, which illustrates a method 500 of paying funds from a MSA/FSA, according to embodiments of the present invention. As with the previously-described methods of the present invention, the method 500 of paying funds from a MSA/FSA is illustrative and not limiting. The method may be implemented in a number of different ways, as is apparent to those skilled in the art in light of this disclosure. The method 500 begins at operation 502, wherein a covered member receives “eligible” services. Presently, only certain services may be paid through a MSA/FSA, which is typically funded with pre-tax income. For example, eligible services may be determined by laws, such as the IRS code. Such services may include, for example, a medical examination for which the covered member's medical insurance coverage was previously verified according to embodiments of the present invention. Thus, at the completion of services, a portion of the fee for the services may be the responsibility of the member. This portion may be a co-payment, a fee for a non-covered service, a co-insurance fee, and/or the like. In some cases, the member's portion of the fee may be know at the completion of services, for example, before the member leaves the doctor's office. In other cases, this may not be known until a claim is processed and underwritten. Other similar possibilities exist.

At operation 504, the covered member may present his insurance card for payment of services and the card is processed through a point-of-sale system. The process may be similar to that described previously with respect to FIG. 3. In this embodiment, however, the “amount” entered may be a code that indicates the member's desire to have the fees paid from his MSA/FSA. Thus, the host computer system will receive information that a member desired to have such fees paid from a MSA/FSA.

In some embodiments, operation 504 is not necessary, for example, because the member elected during an enrollment process to have such fees paid from a MSA/FSA, and the verification process, discussed previously with respect to FIG. 3, initiated such payment.

At operation 506, the host computer system verifies that the member participates in an MSA/FSA. If so, the host computer system returns an approval code that includes an approval number that the provider includes on insurance claim forms relating to the services provided to the member.

Having described several embodiments, it will be recognized by those of skill in the art that various modifications, alternative constructions, and equivalents may be used without departing from the spirit of the invention. Additionally, a number of well known processes and elements have not been described in order to avoid unnecessarily obscuring the present invention. For example, those skilled in the art know how to arrange computers into a network and enable communication among the computers. Additionally, those skilled in the art will realize that the present invention is not limited to verifying medical insurance information via a credit card network. For example, the present invention may be used by rental car agencies to verify automobile insurance for customers, and the like. Accordingly, the above description should not be taken as limiting the scope of the invention, which is defined in the following claims.

What is claimed is:

1. A method of verifying insurance coverage relating to a member, comprising:
receiving at a financial transaction processing computer system a member identifier relating to the member;
searching a database to determine if the member identifier is valid; and
transmitting from the financial transaction processing computer system authorization information.

2. The method of claim 1, wherein the financial transaction processing computer system comprises a credit card processing system.

3. The method of claim 1, wherein the member identifier is received in credit card number format.

4. The method of claim 1, further comprising receiving an individual code at the financial transaction processing computer system.

5. The method of claim 4, wherein the individual code is received in a format relating to currency.

6. The method of claim 1, wherein the insurance coverage relates to medical insurance.

7. The method of claim 1, further comprising receiving at the financial transaction processing computer system an identifier relating to a provider.

8. The method of claim 1, further comprising determining whether the provider is a network provider.

9. The method of claim 1, wherein the authorization information indicates a denial of coverage.

10. The method of claim 1, wherein the authorization information comprises a co-payment.

11. A method of verifying insurance coverage relating to a member, comprising:
entering member identifier information into a credit card processing device;
transmitting the information to a host computer system; and
receiving authorization information at the processing device indicating whether the member has insurance coverage.

12. The method of claim 11, wherein the identifier information comprises an individual code in a currency field.

13. The method of claim 11, wherein the authorization information comprises a co-payment.

14. The method of claim 11, wherein the authorization information indicates a denial of coverage.

15. The method of claim 11, wherein entering member identifier information comprises swiping an insurance card.

16. The method of claim 15, wherein the insurance card comprises credit card stock.

17. An insurance card, comprising:
an account number in credit card number format;
a machine-readable storage medium; and
a list of covered members;
wherein the insurance card comprises credit card stock.

18. The insurance card of claim 17, wherein the insurance card relates to medical insurance.

19. A method of enrolling a member into medical coverage, comprising:
receiving enrollment information from the member;
assigning an account to the member, wherein the account is in credit card format;
assigning a code to each covered dependent of the member, wherein each dependent's code is in currency format; and
producing a card for the member, wherein the card comprises credit card stock.

20. The method of claim 19, further comprising producing dependent codes on the card.

21. The method of claim 19, further comprising entering pre-tax spending account information relating to the member.

22. A system for processing insurance information, comprising:
a credit card processing network; and
a host computer system;
wherein the host computer system is programmed to receive insurance information from a point-of-sale device via the credit card processing network and verify coverage.

23. The system of claim 22, wherein the host computer system is further programmed to determine a dependent's coverage.

24. The system of claim 22, wherein the host computer system is further programmed to determine if a provider is a network provider.

25. The system of claim 22, wherein the host computer system is further programmed to transmit an approval code.

26. The system of claim 25, wherein the approval code comprises a co-payment.

27. The system of claim 25, wherein the approval code comprises a denial of coverage.
